(19) United States
(12) Patent Application Publication
(10) Pub. No.: US 2026/0370437 A1
(43) Pub. Date: Nov. 19, 2026

(54) INTER-FREQUENCY CHANNEL STATE INFORMATION PREDICTION

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US); Min Soo SIM, San Diego, CA (US)

(21) Appl. No.: 19/209,014

(22) Filed: May 15, 2025

(51) Int. Cl. H04L 5/00; H04B 7/06; H04W 36/00

(52) U.S. Cl. CPC H04L 5/0098; H04B 7/0626; H04W 36/00692

(57) ABSTRACT

Various aspects of the present disclosure generally relate to wireless communication. In some aspects, a user equipment (UE) may receive a configuration that indicates a first frequency sub-band and a second frequency sub-band, wherein the first frequency sub-band is associated with measurement and the second frequency sub-band is associated with prediction. The UE may transmit, based at least in part on the configuration, a report that indicates predicted channel state information (CSI) or interference information on the second frequency sub-band. Numerous other aspects are described.

### FIELD OF THE DISCLOSURE

Aspects of the present disclosure generally relate to wireless communication and specifically relate to techniques, apparatuses, and methods associated with inter-frequency channel state information prediction.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at a user equipment (UE) includes one or more memories; and one or more processors, coupled to the one or more memories, configured to cause the UE to: receive a configuration that indicates a first frequency sub-band and a second frequency sub-band, wherein the first frequency sub-band is associated with measurement and the second frequency sub-band is associated with prediction; and transmit, based at least in part on the configuration, a report that indicates predicted channel state information (CSI) or interference information on the second frequency sub-band.

In some implementations, an apparatus for wireless communication at a network node includes one or more memories; and one or more processors, coupled to the one or more memories, configured to cause the network node to: transmit a configuration that indicates a first frequency sub-band and a second frequency sub-band, wherein the first frequency sub-band is associated with measurement and the second frequency sub-band is associated with prediction; and receive, based at least in part on the configuration, a report that indicates predicted CSI or interference information on the second frequency sub-band.

In some implementations, a method of wireless communication performed by a UE includes receiving a configuration that indicates a first frequency sub-band and a second frequency sub-band, wherein the first frequency sub-band is associated with measurement and the second frequency sub-band is associated with prediction; and transmitting, based at least in part on the configuration, a report that indicates predicted CSI or interference information on the second frequency sub-band.

In some implementations, a method of wireless communication performed by a network node includes transmitting a configuration that indicates a first frequency sub-band and a second frequency sub-band, wherein the first frequency sub-band is associated with measurement and the second frequency sub-band is associated with prediction; and receiving, based at least in part on the configuration, a report that indicates predicted CSI or interference information on the second frequency sub-band.

In some implementations, a non-transitory computer-readable medium storing a set of instructions for wireless communication includes one or more instructions that, when executed by one or more processors of a UE, cause the UE to: receive a configuration that indicates a first frequency sub-band and a second frequency sub-band, wherein the first frequency sub-band is associated with measurement and the second frequency sub-band is associated with prediction; and transmit, based at least in part on the configuration, a report that indicates predicted CSI or interference information on the second frequency sub-band.

In some implementations, a non-transitory computer-readable medium storing a set of instructions for wireless communication includes one or more instructions that, when executed by one or more processors of a network node, cause the network node to: transmit a configuration that indicates a first frequency sub-band and a second frequency sub-band, wherein the first frequency sub-band is associated with measurement and the second frequency sub-band is associated with prediction; and receive, based at least in part on the configuration, a report that indicates predicted CSI or interference information on the second frequency sub-band.

In some implementations, an apparatus for wireless communication includes means for receiving a configuration that indicates a first frequency sub-band and a second frequency sub-band, wherein the first frequency sub-band is associated with measurement and the second frequency sub-band is associated with prediction; and means for transmitting, based at least in part on the configuration, a report that indicates predicted CSI or interference information on the second frequency sub-band.

In some implementations, an apparatus for wireless communication includes means for transmitting a configuration that indicates a first frequency sub-band and a second frequency sub-band, wherein the first frequency sub-band is associated with measurement and the second frequency sub-band is associated with prediction; and means for receiving, based at least in part on the configuration, a report that indicates predicted CSI or interference information on the second frequency sub-band.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example associated with inter-frequency channel state information prediction.

FIG. 3 is a flowchart illustrating an example process performed, for example, by a user equipment.

FIG. 4 is a flowchart illustrating an example process performed, for example, by a network node.

FIGS. 5-6 are diagrams of example apparatuses for wireless communication.

### DETAILED DESCRIPTION

Carrier aggregation and dual connectivity enable scheduling a user equipment (UE) with multiple carriers to help increase a bandwidth, which may result in an increased achieved data rate. Efficient carrier aggregation and dual connectivity may face a tradeoff between link performance adaptation and energy savings. To achieve a high link adaptation performance, sufficient channel state information (CSI) measurements may be needed on a plurality of component carriers (CCs) (e.g., all CCs). To enhance energy savings at both a network node and the UE, the network node may refrain from transmitting some reference signals for some CCs. Such reference signals may be configured, but the reference signals may remain inactive to save energy. In these cases, the UE does not measure beams/CSI of secondary component carriers (SCCs). In addition to no channel measurement resources (CMRs), these CCs may have restricted activities. The UE may turn off radio frequency (RF) or baseband processing for these CCs for power saving (up to UE implementation). Such techniques may increase the energy savings but may affect the scheduling and link adaptation performance since the CSI on the SCCs are not (sufficiently) measured. As a result, such techniques may degrade a system performance.

Various aspects relate generally to CSI prediction. Some aspects more specifically relate to inter-frequency CSI prediction for carrier aggregation or dual connectivity. In some examples, a UE may receive, from a network node a configuration that indicates a first frequency sub-band and a second frequency sub-band. In one example, the configuration may indicate a first set of frequency sub-bands and a second set of frequency sub-bands. The first set of frequency sub-bands may include one or more frequency sub-bands, which may include the first frequency sub-band. The second set of frequency sub-bands may include one or more frequency sub-bands, which may include the second frequency sub-band. The UE may receive the configuration for when the UE is operating in a carrier aggregation mode or a dual connectivity mode. The first frequency sub-band may be associated with measurement and the second frequency sub-band may be associated with prediction. The first frequency sub-band may be a first CC or a first bandwidth part (BWP), and the second frequency sub-band may be a second CC or a second BWP. The first frequency sub-band may be a primary CC and the second frequency sub-band may be an SCC. The UE may measure, based at least in part on the configuration, a channel or an interference on the first frequency sub-band. The UE may predict or interpolate, based at least in part on the configuration, predicted CSI or interference information on the second frequency sub-band. The UE may transmit, to the network node and based at least in part on the configuration, a report that indicates the predicted CSI or interference information on the second frequency sub-band.

Particular aspects of the subject matter described in this disclosure can be implemented to realize one or more of the following potential advantages. In some examples, by configuring the first frequency sub-band for measurements and the second frequency sub-band for prediction, the described techniques can be used by the UE to achieve a relatively good link performance adaptation for carrier aggregation or dual connectivity while achieving energy savings. The UE may predict the CSI or the interference on the second frequency sub-band without performing actual measurements on the second frequency sub-band, which may save resources at the UE. The UE may turn off an RF or baseband processing for the second frequency sub-band, which may save power at the UE. The UE may rely on CSI prediction to achieve more carrier aggregation, which may result in an increased throughput, without exceeding the UE's CSI processing capability. As a result, in ability to perform an inter-frequency CSI prediction using configured sets of frequency sub-bands may improve an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

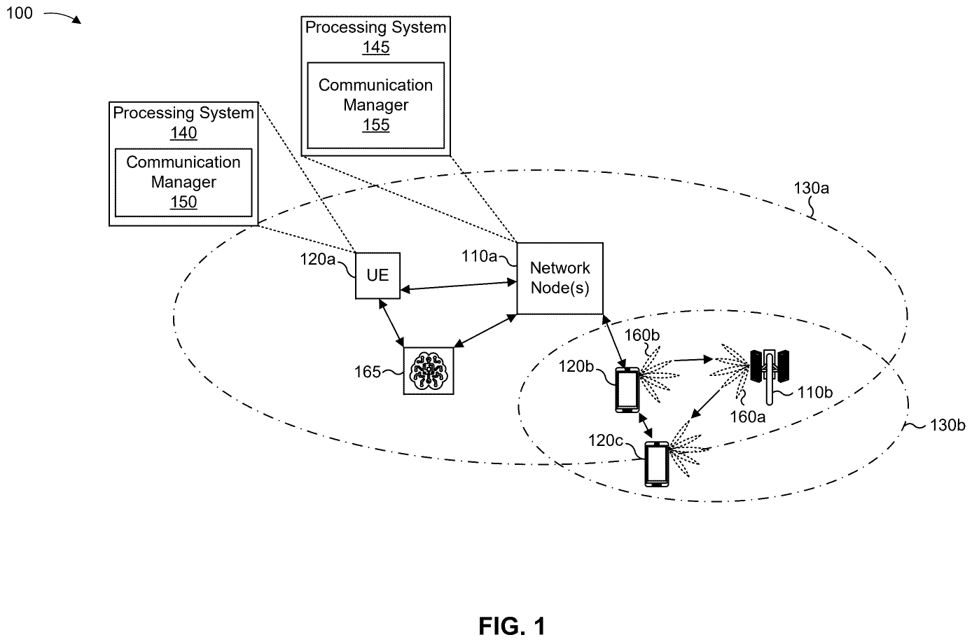

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, CCs, or channels that define associated frequencies available for communications. In some examples, each of the network nodes 110 and the UEs 120 may communicate using one or multiple CCs in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a

DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full CC bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., the UE 120) may include a communication manager 150. As described in more detail elsewhere herein, the communication manager 150 may receive a configuration that indicates a first frequency sub-band and a second frequency sub-band, wherein the first frequency sub-band is associated with measurement and the second frequency sub-band is associated with prediction; and transmit, based at least in part on the configuration, a report that indicates predicted CSI or interference information on the second frequency sub-band. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a configuration that indicates a first frequency sub-band and a second frequency sub-band, wherein the first frequency sub-band is associated with measurement and the second frequency sub-band is associated with prediction; and receive, based at least in part on the configuration, a report that indicates predicted CSI or interference information on the second frequency sub-band. Additionally, or alternatively, the communication manager 155 may perform one or more other operations described herein.

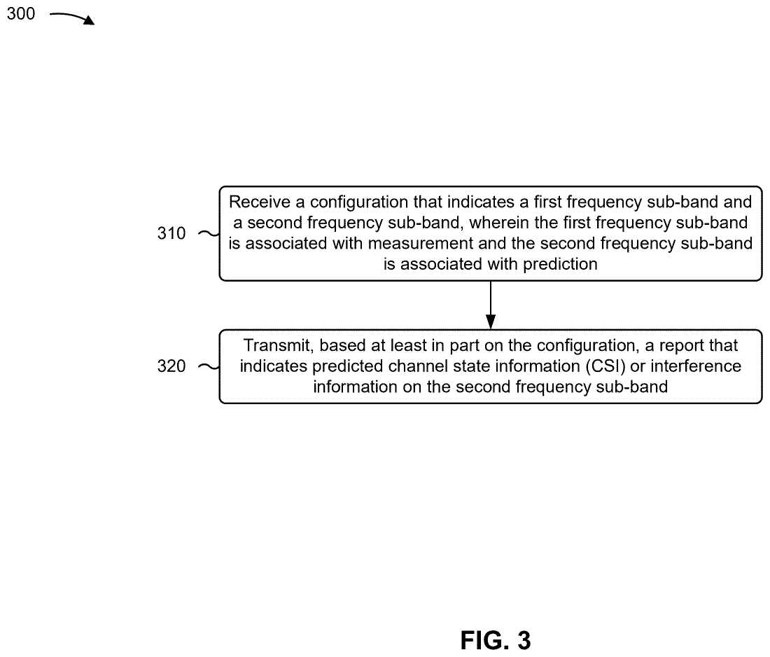

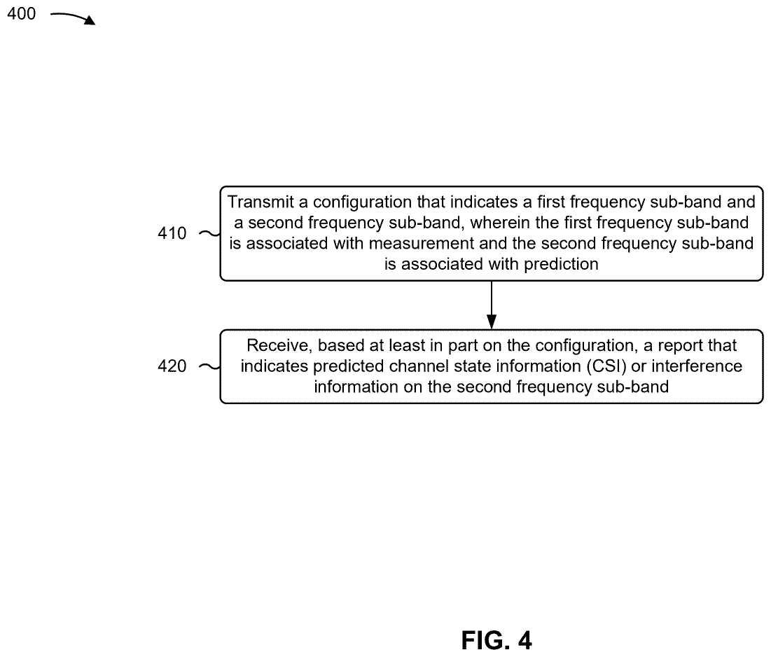

The network node 110, the processing system 145 of the network node 110, the UE 120, the processing system 140 of the UE 120, or any other component(s) of FIG. 1 may implement one or more techniques or perform one or more operations associated with inter-frequency CSI prediction, as described in more detail elsewhere herein. For example, the processing system 145 of the network node 110, or the processing system 140 of the UE 120 may perform or direct operations of, for example, process 300 of FIG. 3, process 400 of FIG. 4, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 300 of FIG. 3, process 400 of FIG. 4, or other processes as described herein. In some examples, executing instructions may include running the instructions, converting the instructions, compiling the instructions, or interpreting the instructions, among other examples.

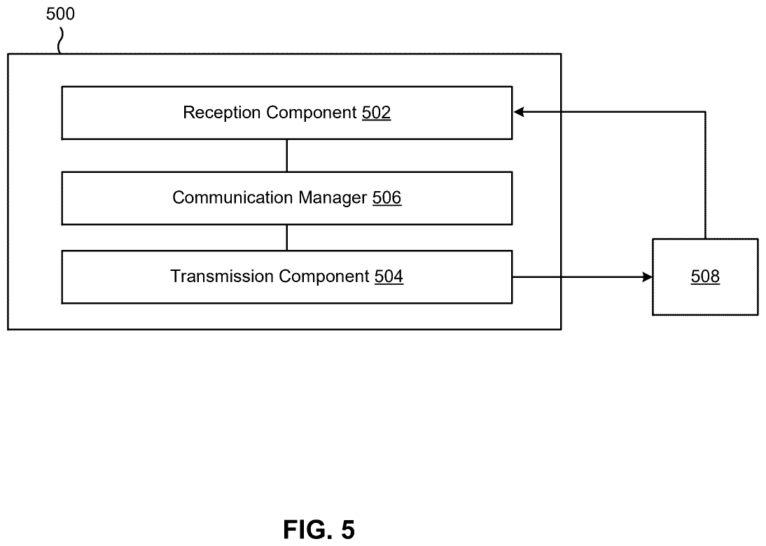

In some aspects, a UE (e.g., the UE 120) includes means for receiving a configuration that indicates a first frequency sub-band and a second frequency sub-band, wherein the first frequency sub-band is associated with measurement and the second frequency sub-band is associated with prediction; or means for transmitting, based at least in part on the configuration, a report that indicates predicted CSI or interference information on the second frequency sub-band. The means for the UE to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

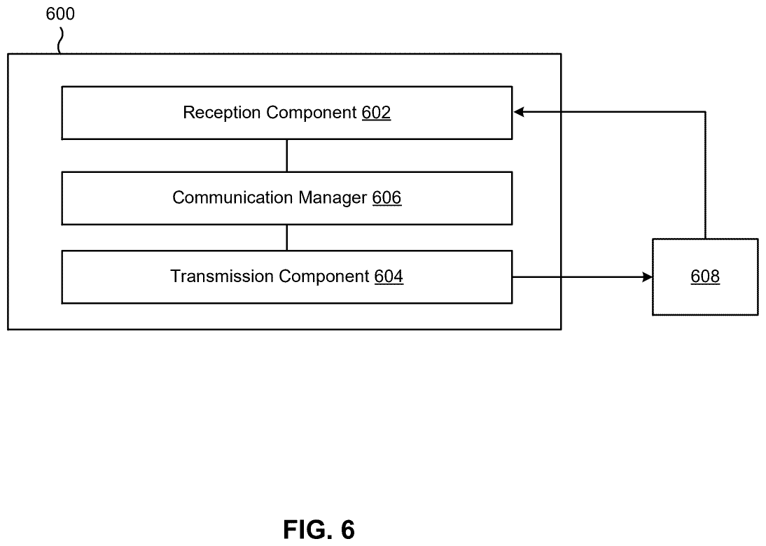

In some aspects, a network node (e.g., the network node 110) includes means for transmitting a configuration that indicates a first frequency sub-band and a second frequency sub-band, wherein the first frequency sub-band is associated with measurement and the second frequency sub-band is associated with prediction; or means for receiving, based at least in part on the configuration, a report that indicates predicted CSI or interference information on the second frequency sub-band. The means for the network node to perform operations described herein may include, for example, one or more of communication manager 155, processing system 145, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

As indicated above, FIG. 1 is provided as an example. Other examples may differ from what is described with regard to FIG. 1.

Carrier aggregation in a 5G NR system is a technique used to enhance data throughput and network efficiency by combining multiple frequency bands into a single data channel. Carrier aggregation allows a UE to simultaneously transmit and receive data across several CCs, effectively increasing an available bandwidth and improving overall data rates. In 5G NR, carrier aggregation may be implemented across different frequency ranges, including sub-6 GHz and millimeter wave bands, enabling flexible deployment strategies to meet diverse service requirements. By aggregating carriers, the system may optimize resource utilization, reduce latency, and support high-demand applications such as eMBB and URLLC, thereby facilitating a more robust and versatile wireless communication environment.

Dual connectivity in the 5G NR system is a feature that enables the UE to maintain simultaneous connections with multiple network nodes, typically involving a combination of 5G NR and LTE technologies. Dual connectivity allows the UE to leverage the strengths of both networks, enhancing data throughput, reliability, and coverage. In dual connectivity, the UE connects to a master node, usually an LTE network node, and a secondary node, typically a 5G NR network node, enabling seamless data transfer and improved mobility management. This setup is particularly beneficial in scenarios where 5G coverage is still expanding, as it ensures continuous service by utilizing an established LTE infrastructure while gradually transitioning to 5G capabilities. Dual connectivity supports advanced use cases by optimizing network resources, reducing latency, and providing a more resilient communication experience.

Carrier aggregation and dual connectivity enable scheduling the UE with multiple carriers to help increase a bandwidth, which may result in an increased achieved data rate. Efficient carrier aggregation and dual connectivity may face a tradeoff between link performance adaptation and energy savings. To achieve a high link adaptation performance, sufficient CSI measurements may be needed on a plurality of CCs (e.g., all CCs). To enhance energy savings at both a network node and the UE, the network node may refrain from transmitting some reference signals for some CCs. For example, the network node may refrain from transmitting a CSI-RS or a CSI interference measurement (CSI-IM) on a primary cell (PCell) or one or more secondary cells (SCells). Such reference signals (e.g., CSI-RS/CSI-IM) may be configured, but the reference signals may remain inactive to save energy. In these cases, the UE does not measure beams/CSI of SCCs. In addition to no CMRs, these CCs may have restricted activities (similar to a dormant/inactive SCell). The UE may turn off RF/baseband processing for these CCs for power saving (up to UE implementation). For example, the UE may implement no PDCCH monitoring, no SRS transmission (time division duplexing (TDD) case), or no random access channel (RACH) transmission (TDD case). Such techniques may increase the energy savings but may affect the scheduling and link adaptation performance since the CSI on the SCCs are not (sufficiently) measured.

In various aspects of techniques and apparatuses described herein, a UE may receive, from a network node a configuration that indicates a first frequency sub-band and a second frequency sub-band. In one example, the configuration may indicate a first set of frequency sub-bands and a second set of frequency sub-bands. The first set of frequency sub-bands may include one or more frequency sub-bands, which may include the first frequency sub-band. The second set of frequency sub-bands may include one or more frequency sub-bands, which may include the second frequency sub-band. The UE may receive the configuration for when the UE is operating in a carrier aggregation mode or a dual connectivity mode. The first frequency sub-band may be associated with measurement and the second frequency sub-band may be associated with prediction. The first frequency sub-band may be a first CC or a first BWP, and the second frequency sub-band may be a second CC or a second BWP. The first frequency sub-band may be a primary CC and the second frequency sub-band may be an SCC. The UE may measure, based at least in part on the configuration, a channel or an interference on the first frequency sub-band. The UE may predict or interpolate, based at least in part on the configuration, predicted CSI or interference information on the second frequency sub-band. The UE may transmit, to the network node and based at least in part on the configuration, a report that indicates the predicted CSI or interference information on the second frequency sub-band.

In some aspects, by configuring the first frequency sub-band for measurements and the second frequency sub-band for prediction, the UE may achieve a relatively good link performance adaptation for carrier aggregation or dual connectivity while achieving energy savings. The UE may predict the CSI or the interference on the second frequency sub-band without performing actual measurements on the second frequency sub-band, which may save resources at the UE. The UE may turn off an RF or baseband processing for the second frequency sub-band, which may save power at the UE. The UE may rely on CSI prediction to achieve more carrier aggregation, which may result in an increased throughput, without exceeding the UE's CSI processing capability. As a result, in ability to perform an inter-frequency CSI prediction using configured sets of frequency sub-bands may improve an overall system performance.

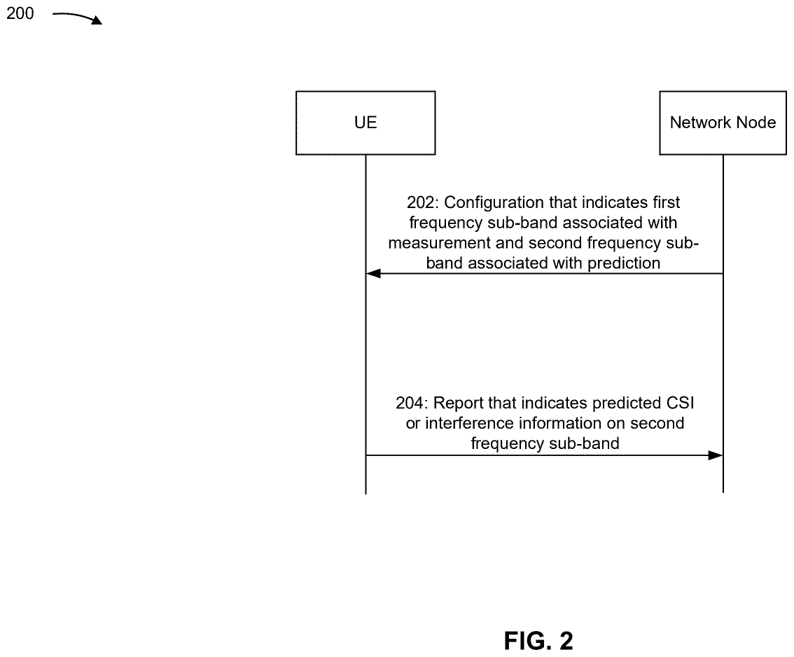

FIG. 2 is a diagram illustrating an example 200 associated with inter-frequency CSI prediction. As shown in FIG. 2, example 200 includes communication between a UE (e.g., UE 120) and a network node (e.g., network node 110). In some aspects, the UE and the network node may be included in a wireless network, such as wireless network 100.

As shown by reference number 202, the UE may receive, from the network node a configuration that indicates a first frequency sub-band and a second frequency sub-band. In one example, the configuration may indicate a first set of frequency sub-bands and a second set of frequency sub-bands. The first set of frequency sub-bands may include one or more frequency sub-bands, which may include the first frequency sub-band. The second set of frequency sub-bands may include one or more frequency sub-bands, which may include the second frequency sub-band. The UE may receive the configuration for when the UE is operating in a carrier aggregation mode or a dual connectivity mode. The first frequency sub-band may be associated with measurement and the second frequency sub-band may be associated with prediction. The UE may receive the configuration via RRC signaling. The first frequency sub-band may be a first CC or a first BWP, and the second frequency sub-band may be a second CC or a second BWP. The first frequency sub-band may be a primary CC and the second frequency sub-band may be an SCC. In some aspects, the configuration may indicate one or more resource sets for measurement and prediction. The one or more resource sets may use a bit or a flag in a configured resource to indicate whether the configured resource is a measurement resource or a prediction resource.

In some aspects, the UE may measure, based at least in part on the configuration, a channel or an interference on the first frequency sub-band. The UE may measure the channel or the interference based at least in part on an SSB, a CSI-RS, or a CSI-IM, which may be received on the first frequency sub-band. In some aspects, the UE may predict or interpolate, based at least in part on the configuration, the predicted CSI or interference information on the second frequency sub-band. In other words, the UE may predict CSI or interference on the second frequency sub-band based at least in part on measurements performed on the first frequency sub-band.

As shown by reference number 204, the UE may transmit, to the network node and based at least in part on the configuration, a report that indicates predicted CSI or interference information on the second frequency sub-band. The UE may transmit the report via an uplink channel of the first frequency sub-band or the second frequency sub-band. The report may indicate a UE prediction. The UE prediction may include a recommendation on whether or not to operate in the carrier aggregation mode or the dual connectivity mode, a recommendation of frequency sub-bands on which the UE is to operate, or partial CSI prediction information. The report may indicate whether the predicted CSI or interference information on the second frequency sub-band is measured or predicted. In some cases, an RF or baseband processing at the UE may be configured to be turned off for one or more frequency sub-bands.

In some aspects, the UE may be configured with two sets of CCs in carrier aggregation or dual connectivity modes. The UE may be configured to measure a channel/interference (e.g., using SSB, CSI-RS, or CSI-IM) on a first set of CCs (e.g., a primary CC) and predict (or interpolate) a CSI/interference on a second set of CCs (e.g., SCCs). The UE may report predicted CSI/interference information to the network node. The network node may configure carrier aggregation to be within a same frequency band (intra-band) or across different frequency bands (inter-band). For intra-band carrier aggregation, CCs may be on contiguous or non-contiguous carriers assigned to the UE. In some aspects, the UE may be configured with two sets of frequency sub-bands (e.g., CCs or BWPs). The UE may be configured to measure the channel/interference on a first set of frequency sub-bands to predict the CSI/interference on a second set of frequency sub-bands, where which may be reported to the network node.

In some aspects, such an approach may provide a reasonable tradeoff between link performance and energy savings. No CMR resources may be needed on SCCs (or only sparse CMRs), which may result in no measurement gap or no RF re-tuning for measurements. The UE may turn off RF/baseband processing for these CCs for power savings. An additional amount of CC aggregation may be allowed (to increase throughput) by relying on prediction without exceeding the UE's CSI processing capability.

In some aspects, network configurations and UE reporting for CC prediction may be defined. The UE may be configured to measure CSI on a first set of measurement CCs to predict CSI information on a second set of prediction CCs. The UE may be configured to report a predicted CSI on a PUCCH/PUSCH of a primary CC or on a PUCCH/PUSCH of one or more predicted CCs. A UE prediction on the second set of prediction CCs may be a simple recommendation on whether or not to operate in the carrier aggregation or dual connectivity mode. The UE prediction may include a recommendation of SCCs that the UE should operate on. The UE prediction may include partial CSI prediction information. The partial CSI prediction information may indicate information regarding a beam, interference, CSI-RS resource indicator (CRI), SSBRI, RSRP, signal-to-interference plus noise ratio (SINR), CQI, PMI, or RI. The network node may indicate measurement and prediction CC sets by extending CSI report and/or CSI-resource configuration frameworks. For example, the network node may use an additional bit/flag in configured resources to indicate whether the configured resource is a measurement resource or a prediction resource. A longer scheduling offset may be needed for the one or more predicted CCs. A scheduling offset may be the time between when a scheduling grant is received and when a corresponding data transmission or reception occurs. The longer scheduling offset may be needed to wake-up inactive CCs.

In some aspects, the UE may report whether a certain CC is measured or predicted. In some UE implementations, the UE may turn off RF/baseband processing for one or more SCCs for power saving. In this case, when channel reference signals (e.g., CSI-RS/SSBs) are transmitted on such SCCs, the UE may not measure the channel reference signals and instead may predict the channel reference signals. When reporting the predicted CSI for the one or more SCCs, the UE may be configured to report whether such CCs are measured or predicted, which may resolve an ambiguity at the network node of whether the one or more SCCs are measured and not predicted. The network node may configure the UE to autonomously switch between reporting measured or predicted CSI information for the one or more SCCs when the RF/baseband processing are switched off for the one or more SCCs. Alternatively, the network node may configure the UE to avoid reporting SCC CSI information when not measured (e.g., to ensure higher accuracy). When reporting predicted SCCs, the UE may also be configured to associate the report with a confidence level in prediction.

In some aspects, the UE may measure one or more monitoring reference signals to monitor a prediction performance. The prediction performance may be calculated based at least in part on a comparison of CSI predicted on the second frequency sub-band and CSI measured using the one or more monitoring reference signals. The UE may transmit, to the network node, an indication of the prediction performance.

In some aspects, regarding performance monitoring, the UE may be configured to measure persistent, semi-persistent, or aperiodic monitoring reference signals (e.g., CSI-RSs) on a (subset of) second set of CCs to monitor a prediction performance. The prediction performance may be calculated by comparing CSI predicted on the second set of CCs with CSI measured using monitoring reference signals. For example, the UE may calculate an absolute difference between a predicted CSI and a CSI measured using a monitoring reference signal (e.g., RSRP, CQI, or RI). As another example, the UE may calculate a square generalized cosine similarity (SGCS) of a predicted precoder/channel and a precoder/channel measured using a monitoring link. For a UE side performance monitoring, the UE may be configured to report a CC prediction error/similarity performance to the network node. For a network-side performance monitoring, the UE may be configured to report both measured and predicted CSIs to the network node. The UE may be configured to average an error/similarity performance of CC prediction on multiple monitoring occasions and report the prediction performance to the network node. The UE may recommend/request from the network node to send monitoring reference signals so that the UE is able to monitor its CC prediction performance. When requesting monitoring reference signals to be transmitted, the UE may request monitoring specific CCs. Depending on the performance monitoring, the UE may be configured to continue using a same AI/ML model, fallback to a non-AI/ML operation, fine-tune or switch the AI/ML model, or receive a new AI/ML model from the network node.

In some aspects, the predicted CSI or interference information may be obtained based at least in part on an AI/ML model. The UE may determine to continue using the AI/ML model based at least in part on a performance monitoring. The UE may fall back to a non-AI/ML operation based at least in part on the performance monitoring. The UE may fine-tine or switch an AI/ML mode based at least in part on the performance monitoring. The UE may receive, from the network node, a new AI/ML model based at least in part on the performance monitoring. In some aspects, the predicted CSI or interference information may be obtained based at least in part on an AI/ML model. Input data and output data to the AI/ML model may be consistent across training and inference. An input to the AI/ML model may be a measured channel or interference on the first frequency sub-band. An output of the AI/ML model may be the predicted CSI or interference information on the second frequency sub-band.

In some aspects, a consistency between training and inference for CC predication may be ensured. Input data and output data to the AI/ML model may be consistent across training and inference. For example, during training and inference, consistent inputs may be provided to the AI/ML model for CC prediction, where the AI/ML may produce consistent outputs. The input data to the AI/ML model may be the measured channel/interference (e.g., using SSBs, CSI-RS, or CSI-IM) on a set (or single) CC to allow predicting channel/interference conditions on a second CC. The output data may be the predicted CSI. An associated identifier (ID) may be used to indicate a consistency of network-side additional conditions. Consistency conditions may include consistent network-side spatial relationships between training and inference.

In some aspects, additional consistency requirements between training and inference may be satisfied for CC prediction. For example, whether the AI/ML model is performing inter-band or intra-band CCs prediction is to be consistent across training and inference. Bands/CCs used as input and output to the AI/ML model is to be consistent across training and inference. A CC frequency separation consistency may be maintained. A frequency separation between a set of measured and predicted CCs is to be consistent across training and inference. A numerology consistency for intra-band CC prediction may be maintained. Numerologies (e.g., SCS) of CCs used as input and output of the AI/ML model is to be consistent across training and inference.

In some aspects, the UE may transmit, to the network node and during a data collection mode, a request for a plurality of reference signals on a plurality of frequency sub-bands. The UE may receive, from the network node and in response to the request, the plurality of reference signals on the plurality of frequency sub-bands. A prediction model may be trained based at least in part on the plurality of reference signals on the plurality of frequency sub-bands. In some aspects, the UE may transmit, to the network node, a UE capability indication. The UE capability indication may indicate whether or not CSI prediction is supported. The UE capability indication may indicate supported bands for CSI prediction. The UE capability indication may indicate whether CSI prediction for the carrier aggregation mode or the dual connectivity mode is supported. The UE capability indication may indicate whether inter-band CSI prediction or intra-band CSI prediction is supported. The UE capability indication may indicate one or more numerologies associated with CSI prediction. The UE capability indication may indicate a scheduling offset associated with CSI prediction. The UE capability indication may indicate a frequency separation associated with CSI prediction.

In some aspects, in a data collection mode, the UE may be configured with reference signals on multiple CCs to be able to train/fine-tune its AI/ML model. The UE may request, from the network node, to transmit reference signals on multiple CCs so that the UE is able to collect data to train/fine-tune its AI/ML model. The UE may request, from the network node, to send the reference signals on specific CCs during data collection.

In some aspects, regarding a UE capability, the UE may report its capability of whether or not the UE supports CC prediction. The UE may report its capability on supported bands for CC prediction. A UE capability reporting may include whether the UE supports CC prediction for the carrier aggregation mode or the dual connectivity mode or both. The UE capability reporting may include whether the UE supports inter-band or intra-band CC prediction. The UE may report its capability on the numerologies (or SCS) of the CC that is predicted. The UE may report its capability on a scheduling offset for predicting CCs. The UE may report its capability on a CC frequency separation that is predicted. Network configurations may be performed via RRC signaling and activated/deactivated through a MAC-CE or DCI.

As indicated above, FIG. 2 is provided as an example. Other examples may differ from what is described with regard to FIG. 2.

FIG. 3 is a diagram illustrating an example process 300 performed, for example, at a UE or an apparatus of a UE. Example process 300 is an example where the apparatus or the UE (e.g., UE 120) performs operations associated with inter-frequency CSI prediction.

As shown in FIG. 3, in some aspects, process 300 may include receiving a configuration that indicates a first frequency sub-band and a second frequency sub-band, wherein the first frequency sub-band is associated with measurement and the second frequency sub-band is associated with prediction (block 310). For example, the UE (e.g., using reception component 502 or communication manager 506, depicted in FIG. 5) may receive a configuration that indicates a first frequency sub-band and a second frequency sub-band, wherein the first frequency sub-band is associated with measurement and the second frequency sub-band is associated with prediction, as described above in connection with FIG. 2.

As further shown in FIG. 3, in some aspects, process 300 may include transmitting, based at least in part on the configuration, a report that indicates predicted CSI or interference information on the second frequency sub-band (block 320). For example, the UE (e.g., using transmission component 504 or communication manager 506, depicted in FIG. 5) may transmit, based at least in part on the configuration, a report that indicates predicted CSI or interference information on the second frequency sub-band, as described above in connection with FIG. 2.

Process 300 may include additional aspects, such as any single aspect or any combination of aspects described below or in connection with one or more other processes described elsewhere herein.

In a first aspect, process 300 includes measuring, based at least in part on the configuration, a channel or an interference on the first frequency sub-band based at least in part on an SSB, a CSI-RS, or a CSI-IM, and predicting or interpolating, based at least in part on the configuration, the predicted CSI or interference information on the second frequency sub-band.

In a second aspect, alone or in combination with the first aspect, the first frequency sub-band is a first CC or a first BWP, and the second frequency sub-band is a second CC or a second BWP.

In a third aspect, alone or in combination with one or more of the first and second aspects, the first frequency sub-band is a primary CC and the second frequency sub-band is an SCC.

In a fourth aspect, alone or in combination with one or more of the first through third aspects, process 300 includes transmitting the report via an uplink channel of the first frequency sub-band or the second frequency sub-band.

In a fifth aspect, alone or in combination with one or more of the first through fourth aspects, the report indicates a UE prediction, and the UE prediction includes one or more of a recommendation on whether or not to operate in the carrier aggregation mode or the dual connectivity mode, a recommendation of frequency sub-bands on which the UE is to operate, or partial CSI prediction information.

In a sixth aspect, alone or in combination with one or more of the first through fifth aspects, the configuration indicates one or more resource sets for measurement and prediction, and the one or more resource sets uses a bit or a flag in a configured resource to indicate whether the configured resource is a measurement resource or a prediction resource.

In a seventh aspect, alone or in combination with one or more of the first through sixth aspects, the report indicates whether the predicted CSI or interference information on the second frequency sub-band is measured or predicted.

In an eighth aspect, alone or in combination with one or more of the first through seventh aspects, process 300 includes measuring one or more monitoring reference signals to monitor a prediction performance, wherein the prediction performance is calculated based at least in part on a comparison of CSI predicted on the second frequency sub-band and CSI measured using the one or more monitoring reference signals, and transmitting an indication of the prediction performance.

In a ninth aspect, alone or in combination with one or more of the first through eighth aspects, the predicted CSI or interference information is obtained based at least in part on an AI/ML model, and process 300 includes determining to continue using the AI/ML model based at least in part on a performance monitoring, falling back to a non-AI/ML operation based at least in part on the performance monitoring, fine-tuning or switching an AI/ML mode based at least in part on the performance monitoring, or receiving a new AI/ML model based at least in part on the performance monitoring.

In a tenth aspect, alone or in combination with one or more of the first through ninth aspects, the predicted CSI or interference information is obtained based at least in part on an AI/ML model, wherein input data and output data to the AI/ML model is consistent across training and inference, wherein an input to the AI/ML model is a measured channel or interference on the first frequency sub-band, and an output of the AI/ML model is the predicted CSI or interference information on the second frequency sub-band.

In an eleventh aspect, alone or in combination with one or more of the first through tenth aspects, process 300 includes transmitting, during a data collection mode, a request for a plurality of reference signals on a plurality of frequency sub-bands, and receiving, in response to the request, the plurality of reference signals on the plurality of frequency sub-bands, wherein a prediction model is trained based at least in part on the plurality of reference signals on the plurality of frequency sub-bands.

In a twelfth aspect, alone or in combination with one or more of the first through eleventh aspects, process 300 includes transmitting a UE capability indication that indicates one or more of whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.

In a thirteenth aspect, alone or in combination with one or more of the first through twelfth aspects, process 400 includes receiving the configuration for when the UE is operating in a carrier aggregation mode or a dual connectivity mode.

Although FIG. 3 shows example blocks of process 300, in some aspects, process 300 may include additional blocks, fewer blocks, different blocks, or differently arranged blocks than those depicted in FIG. 3. Additionally, or alternatively, two or more of the blocks of process 300 may be performed in parallel.

FIG. 4 is a diagram illustrating an example process 400 performed, for example, at a network node or an apparatus of a network node. Example process 400 is an example where the apparatus or the network node (e.g., network node 110) performs operations associated with inter-frequency CSI prediction.

As shown in FIG. 4, in some aspects, process 400 may include transmitting a configuration that indicates a first frequency sub-band and a second frequency sub-band, wherein the first frequency sub-band is associated with measurement and the second frequency sub-band is associated with prediction (block 410). For example, the network node (e.g., using transmission component 604 or communication manager 606, depicted in FIG. 6) may transmit a configuration that indicates a first frequency sub-band and a second frequency sub-band, wherein the first frequency sub-band is associated with measurement and the second frequency sub-band is associated with prediction, as described above in connection with FIG. 2.

As further shown in FIG. 4, in some aspects, process 400 may include receiving, based at least in part on the configuration, a report that indicates predicted CSI or interference information on the second frequency sub-band (block 420). For example, the network node (e.g., using reception component 602 or communication manager 606, depicted in FIG. 6) may receive, based at least in part on the configuration, a report that indicates predicted CSI or interference information on the second frequency sub-band, as described above in connection with FIG. 2.

Process 400 may include additional aspects, such as any single aspect or any combination of aspects described below or in connection with one or more other processes described elsewhere herein.

In a first aspect, process 400 includes a channel or an interference on the first frequency sub-band is measured based at least in part on the configuration, and the predicted CSI or interference information on the second frequency sub-band is obtained based at least in part on the configuration.

In a second aspect, alone or in combination with the first aspect, the first frequency sub-band is a first CC or a first BWP, and the second frequency sub-band is a second CC or a second BWP.

In a third aspect, alone or in combination with one or more of the first and second aspects, the first frequency sub-band is a primary CC and the second frequency sub-band is an SCC.

In a fourth aspect, alone or in combination with one or more of the first through third aspects, process 400 includes receiving the report via an uplink channel of the first frequency sub-band or the second frequency sub-band.

In a fifth aspect, alone or in combination with one or more of the first through fourth aspects, the report indicates a UE prediction, and the UE prediction includes one or more of a recommendation on whether or not to operate in the carrier aggregation mode or the dual connectivity mode, a recommendation of frequency sub-bands on which the UE is to operate, or partial CSI prediction information.

In a sixth aspect, alone or in combination with one or more of the first through fifth aspects, the configuration indicates one or more resource sets for measurement and prediction, and the one or more resource sets uses a bit or a flag in a configured resource to indicate whether the configured resource is a measurement resource or a prediction resource.

In a seventh aspect, alone or in combination with one or more of the first through sixth aspects, the report indicates whether the predicted CSI or interference information on the second frequency sub-band is measured or predicted.

In an eighth aspect, alone or in combination with one or more of the first through seventh aspects, process 400 includes receiving an indication of a prediction performance, wherein one or more monitoring reference signals are measured to monitor the prediction performance, and the prediction performance is based at least in part on a comparison of CSI predicted on the second frequency sub-band and CSI measured using the one or more monitoring reference signals.

In a ninth aspect, alone or in combination with one or more of the first through eighth aspects, the predicted CSI or interference information is obtained based at least in part on an AI/ML model, and process 400 includes transmitting a new AI/ML model based at least in part on a performance monitoring.

In a tenth aspect, alone or in combination with one or more of the first through ninth aspects, the predicted CSI or interference information is obtained based at least in part on an AI/ML model, wherein input data and output data to the AI/ML model is consistent across training and inference, wherein an input to the AI/ML model is a measured channel or interference on the first frequency sub-band, and an output of the AI/ML model is the predicted CSI or interference information on the second frequency sub-band.

In an eleventh aspect, alone or in combination with one or more of the first through tenth aspects, process 400 includes receiving, during a data collection mode, a request for a plurality of reference signals on a plurality of frequency sub-bands, and transmitting, in response to the request, the plurality of reference signals on the plurality of frequency sub-bands, wherein a prediction model is trained based at least in part on the plurality of reference signals on the plurality of frequency sub-bands.

In a twelfth aspect, alone or in combination with one or more of the first through eleventh aspects, process 400 includes receiving a UE capability indication that indicates one or more of whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.

In a thirteenth aspect, alone or in combination with one or more of the first through twelfth aspects, process 400 includes transmitting the configuration for when a UE is operating in a carrier aggregation mode or a dual connectivity mode.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication. The apparatus 500 may be a UE, or a UE may include the apparatus 500. In some aspects, the apparatus 500 includes a reception component 502, a transmission component 504, or a communication manager 506, which may be in communication with one another (for example, via one or more buses or one or more other components). In some aspects, the communication manager 506 is the communication manager 150 described in connection with FIG. 1. As shown, the apparatus 500 may communicate with another apparatus 508, such as a UE or a network node (such as a CU, a DU, an RU, or a base station), using the reception component 502 and the transmission component 504. The communication manager 506 may be included in, or implemented via, a processing system (for example, the processing system 140 described in connection with FIG. 1) of the UE.

In some aspects, the apparatus 500 may be configured to perform one or more operations described herein in connection with FIG. 2. Additionally, or alternatively, the apparatus 500 may be configured to perform one or more processes described herein, such as process 300 of FIG. 3. In some aspects, the apparatus 500 or one or more components shown in FIG. 5 may include one or more components of the UE described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 502 may receive communications, such as reference signals, control information, data communications, or a combination thereof, from the apparatus 508. The reception component 502 may provide received communications to one or more other components of the apparatus 500. In some aspects, the reception component 502 may perform signal processing on the received communications, and may provide the processed signals to the one or more other components of the apparatus 500. In some aspects, the reception component 502 may include one or more components of the UE described above in connection with FIG. 1, such as a radio, one or more RF chains, one or more transceivers, or one or more modems, each of which may in turn be coupled with one or more antennas of the UE.

The transmission component 504 may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications, and may transmit the processed signals to the apparatus 508. In some aspects, the transmission component 504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 504 may be co-located with the reception component 502.

The communication manager 506 may support operations of the reception component 502 or the transmission component 504. For example, the communication manager 506 may receive information associated with configuring reception of communications by the reception component 502 or transmission of communications by the transmission component 504. Additionally, or alternatively, the communication manager 506 may generate or provide control information to the reception component 502 or the transmission component 504 to control reception or transmission of communications.

The reception component 502 may receive a configuration that indicates a first frequency sub-band and a second frequency sub-band, wherein the first frequency sub-band is associated with measurement and the second frequency sub-band is associated with prediction. The transmission component 504 may transmit, based at least in part on the configuration, a report that indicates predicted CSI or interference information on the second frequency sub-band.

The communication manager 506 may measure, based at least in part on the configuration, a channel or an interference on the first frequency sub-band based at least in part on an SSB, a CSI-RS, or a CSI-IM. The communication manager 506 may predict or interpolate, based at least in part on the configuration, the predicted CSI or interference information on the second frequency sub-band. The communication manager 506 may measure one or more monitoring reference signals to monitor a prediction performance, wherein the prediction performance is calculated based at least in part on a comparison of CSI predicted on the second frequency sub-band and CSI measured using the one or more monitoring reference signals. The transmission component 504 may transmit an indication of the prediction performance. The transmission component 504 may transmit, during a data collection mode, a request for a plurality of reference signals on a plurality of frequency sub-bands. The reception component 502 may receive, in response to the request, the plurality of reference signals on the plurality of frequency sub-bands, wherein a prediction model is trained based at least in part on the plurality of reference signals on the plurality of frequency sub-bands. The transmission component 504 may transmit a UE capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction. The reception component 502 may receive the configuration for when the UE is operating in a carrier aggregation mode or a dual connectivity mode.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

FIG. 6 is a diagram of an example apparatus 600 for wireless communication. The apparatus 600 may be a network node, or a network node may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 155 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 145 described in connection with FIG. 1) of the network node.

In some aspects, the apparatus 600 may be configured to perform one or more operations described herein in connection with FIG. 2. Additionally, or alternatively, the apparatus 600 may be configured to perform one or more processes described herein, such as process 400 of FIG. 4. In some aspects, the apparatus 600 or one or more components shown in FIG. 6 may include one or more components of the network node described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the network node described above in connection with FIG. 1, such as a radio, one or more RF chains, one or more transceivers, or one or more modems, each of which may in turn be coupled with one or more antennas of the network node. In some aspects, the reception component 602 or the transmission component 604 may include or may be included in a network interface. The network interface may be configured to obtain or output signals for the apparatus 600 via one or more communications links, such as a backhaul link, a midhaul link, or a fronthaul link.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The transmission component 604 may transmit a configuration that indicates a first frequency sub-band and a second frequency sub-band, wherein the first frequency sub-band is associated with measurement and the second frequency sub-band is associated with prediction. The reception component 602 may receive, based at least in part on the configuration, a report that indicates predicted CSI or interference information on the second frequency sub-band.

The reception component 602 may receive an indication of a prediction performance, wherein one or more monitoring reference signals are measured to monitor the prediction performance, and wherein the prediction performance is based at least in part on a comparison of CSI predicted on the second frequency sub-band and CSI measured using the one or more monitoring reference signals. The reception component 602 may receive, during a data collection mode, a request for a plurality of reference signals on a plurality of frequency sub-bands. The transmission component 604 may transmit, in response to the request, the plurality of reference signals on the plurality of frequency sub-bands, wherein a prediction model is trained based at least in part on the plurality of reference signals on the plurality of frequency sub-bands. The reception component 602 may receive a UE capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction. The transmission component 604 may transmit the configuration for when a UE is operating in a carrier aggregation mode or a dual connectivity mode.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:
Aspect 1: A method of wireless communication performed by a user equipment (UE), comprising: receiving a configuration that indicates a first frequency sub-band and a second frequency sub-band, wherein the first frequency sub-band is associated with measurement and the second frequency sub-band is associated with prediction; and transmitting, based at least in part on the configuration, a report that indicates predicted channel state information (CSI) or interference information on the second frequency sub-band.
Aspect 2: The method of Aspect 1, further comprising: measuring, based at least in part on the configuration, a channel or an interference on the first frequency sub-band based at least in part on a synchronization signal block, a channel state information reference signal, or a channel state information interference measurement; and predicting or interpolating, based at least in part on the configuration, the predicted CSI or interference information on the second frequency sub-band.
Aspect 3: The method of any of Aspects 1-2, wherein the first frequency sub-band is a first component carrier (CC) or a first bandwidth part (BWP), and wherein the second frequency sub-band is a second CC or a second BWP.
Aspect 4: The method of any of Aspects 1-3, wherein the first frequency sub-band is a primary component carrier and the second frequency sub-band is a secondary component carrier.
Aspect 5: The method of any of Aspects 1-4, wherein transmitting the report is via an uplink channel of the first frequency sub-band or the second frequency sub-band.
Aspect 6: The method of any of Aspects 1-5, wherein the report indicates a UE prediction, and wherein the UE prediction includes one or more of: a recommendation on whether or not to operate in the carrier aggregation mode or the dual connectivity mode, a recommendation of frequency sub-bands on which the UE is to operate, or partial CSI prediction information.
Aspect 7: The method of any of Aspects 1-6, wherein the configuration indicates one or more resource sets for measurement and prediction, and wherein the one or more resource sets uses a bit or a flag in a configured resource to indicate whether the configured resource is a measurement resource or a prediction resource.
Aspect 8: The method of any of Aspects 1-7, wherein the report indicates whether the predicted CSI or interference information on the second frequency sub-band is measured or predicted.
Aspect 9: The method of any of Aspects 1-8, further comprising: measuring one or more monitoring reference signals to monitor a prediction performance, wherein the prediction performance is calculated based at least in part on a comparison of CSI predicted on the second frequency sub-band and CSI measured using the one or more monitoring reference signals; and transmitting an indication of the prediction performance.
Aspect 10: The method of any of Aspects 1-9, wherein the predicted CSI or interference information is obtained based at least in part on an artificial intelligence or machine learning (AI/ML) model, and further comprising: determining to continue using the AI/ML model based at least in part on a performance monitoring; falling back to a non-AI/ML operation based at least in part on the performance monitoring; fine-tuning or switching an AI/ML mode based at least in part on the performance monitoring; or receiving a new AI/ML model based at least in part on the performance monitoring.
Aspect 11: The method of any of Aspects 1-10, wherein the predicted CSI or interference information is obtained based at least in part on an artificial intelligence or machine learning (AI/ML) model, wherein input data and output data to the AI/ML model is consistent across training and inference, wherein an input to the AI/ML model is a measured channel or interference on the first frequency sub-band, and wherein an output of the AI/ML model is the predicted CSI or interference information on the second frequency sub-band.
Aspect 12: The method of any of Aspects 1-11, further comprising: transmitting, during a data collection mode, a request for a plurality of reference signals on a plurality of frequency sub-bands; and receiving, in response to the request, the plurality of reference signals on the plurality of frequency sub-bands, wherein a prediction model is trained based at least in part on the plurality of reference signals on the plurality of frequency sub-bands.
Aspect 13: The method of any of Aspects 1-12, further comprising: transmitting a UE capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.
Aspect 14: The method of any of Aspects 1-13, further comprising: receiving the configuration for when the UE is operating in a carrier aggregation mode or a dual connectivity mode.
Aspect 15: A method of wireless communication performed by a network node, comprising: transmitting a configuration that indicates a first frequency sub-band and a second frequency sub-band, wherein the first frequency sub-band is associated with measurement and the second frequency sub-band is associated with prediction; and receiving, based at least in part on the configuration, a report that indicates predicted channel state information (CSI) or interference information on the second frequency sub-band.
Aspect 16: The method of Aspect 15, wherein: a channel or an interference on the first frequency sub-band is measured based at least in part on the configuration; and the predicted CSI or interference information on the second frequency sub-band is obtained based at least in part on the configuration.
Aspect 17: The method of any of Aspects 15-16, wherein the first frequency sub-band is a first component carrier (CC) or a first bandwidth part (BWP), and wherein the second frequency sub-band is a second CC or a second BWP.
Aspect 18: The method of any of Aspects 15-17, wherein the first frequency sub-band is a primary component carrier and the second frequency sub-band is a secondary component carrier.
Aspect 19: The method of any of Aspects 15-18, wherein receiving the report is via an uplink channel of the first frequency sub-band or the second frequency sub-band.
Aspect 20: The method of any of Aspects 15-19, wherein the report indicates a user equipment (UE) prediction, and wherein the UE prediction includes one or more of: a recommendation on whether or not to operate in the carrier aggregation mode or the dual connectivity mode, a recommendation of frequency sub-bands on which the UE is to operate, or partial CSI prediction information.
Aspect 21: The method of any of Aspects 15-20, wherein the configuration indicates one or more resource sets for measurement and prediction, and wherein the one or more resource sets uses a bit or a flag in a configured resource to indicate whether the configured resource is a measurement resource or a prediction resource.
Aspect 22: The method of any of Aspects 15-21, wherein the report indicates whether the predicted CSI or interference information on the second frequency sub-band is measured or predicted.
Aspect 23: The method of any of Aspects 15-22, further comprising: receiving an indication of a prediction performance, wherein one or more monitoring reference signals are measured to monitor the prediction performance, and wherein the prediction performance is based at least in part on a comparison of CSI predicted on the second frequency sub-band and CSI measured using the one or more monitoring reference signals.
Aspect 24: The method of any of Aspects 15-23, wherein the predicted CSI or interference information is obtained based at least in part on an artificial intelligence or machine learning (AI/ML) model, and further comprising: transmitting a new AI/ML model based at least in part on a performance monitoring.
Aspect 25: The method of any of Aspects 15-24, wherein the predicted CSI or interference information is obtained based at least in part on an artificial intelligence or machine learning (AI/ML) model, wherein input data and output data to the AI/ML model is consistent across training and inference, wherein an input to the AI/ML model is a measured channel or interference on the first frequency sub-band, and wherein an output of the AI/ML model is the predicted CSI or interference information on the second frequency sub-band.
Aspect 26: The method of any of Aspects 15-25, further comprising: receiving, during a data collection mode, a request for a plurality of reference signals on a plurality of frequency sub-bands; and transmitting, in response to the request, the plurality of reference signals on the plurality of frequency sub-bands, wherein a prediction model is trained based at least in part on the plurality of reference signals on the plurality of frequency sub-bands.
Aspect 27: The method of any of Aspects 15-26, further comprising: receiving a user equipment capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.
Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.
Aspect 29: An apparatus for wireless communication at a device, the apparatus comprising one or more memories and one or more processors coupled to the one or more memories, the one or more processors configured to cause the device to perform the method of one or more of Aspects 1-27.
Aspect 30: An apparatus for wireless communication, the apparatus comprising at least one means for performing the method of one or more of Aspects 1-27.
Aspect 31: A non-transitory computer-readable medium storing code for wireless communication, the code comprising instructions executable by one or more processors to perform the method of one or more of Aspects 1-27.
Aspect 32: A non-transitory computer-readable medium storing a set of instructions for wireless communication, the set of instructions comprising one or more instructions that, when executed by one or more processors of a device, cause the device to perform the method of one or more of Aspects 1-27.
Aspect 33: A device for wireless communication, the device comprising a processing system that includes one or more processors and one or more memories coupled with the one or more processors, the processing system configured to cause the device to perform the method of one or more of Aspects 1-27.
Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.
Aspect 35: A device comprising a processing system that includes one or more processors and one or more code-storing memories coupled with the one or more processors, the processing system configured to cause the device to perform the method of one or more of Aspects 1-27.
Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration that indicates a first frequency sub-band and a second frequency sub-band, wherein the first frequency sub-band is associated with measurement and the second frequency sub-band is associated with prediction; and
transmit, based at least in part on the configuration, a report that indicates predicted channel state information (CSI) or interference information on the second frequency sub-band.

2. The apparatus of claim 1, wherein the one or more processors are further configured to cause the UE to:
receive the configuration for when the UE is operating in a carrier aggregation mode or a dual connectivity mode.

3. The apparatus of claim 1, wherein the one or more processors are further configured to cause the UE to:
measure, based at least in part on the configuration, a channel or an interference on the first frequency sub-band based at least in part on a synchronization signal block, a channel state information reference signal, or a channel state information interference measurement; and
predict or interpolate, based at least in part on the configuration, the predicted CSI or interference information on the second frequency sub-band.

4. The apparatus of claim 1, wherein the first frequency sub-band is a first component carrier (CC) or a first bandwidth part (BWP), and wherein the second frequency sub-band is a second CC or a second BWP.

5. The apparatus of claim 1, wherein the first frequency sub-band is a primary component carrier and the second frequency sub-band is a secondary component carrier.

6. The apparatus of claim 1, wherein the one or more processors are further configured to cause the UE to:
transmit the report via an uplink channel of the first frequency sub-band or the second frequency sub-band.

7. The apparatus of claim 1, wherein the report indicates a UE prediction, and wherein the UE prediction includes one or more of: a recommendation on whether or not to operate in the carrier aggregation mode or the dual connectivity mode, a recommendation of frequency sub-bands on which the UE is to operate, or partial CSI prediction information.

8. The apparatus of claim 1, wherein the configuration indicates one or more resource sets for measurement and prediction, and wherein the one or more resource sets uses a bit or a flag in a configured resource to indicate whether the configured resource is a measurement resource or a prediction resource.

9. The apparatus of claim 1, wherein the report indicates whether the predicted CSI or interference information on the second frequency sub-band is measured or predicted.

10. The apparatus of claim 1, wherein the one or more processors are further configured to cause the UE to:
measure one or more monitoring reference signals to monitor a prediction performance, wherein the prediction performance is calculated based at least in part on a comparison of CSI predicted on the second frequency sub-band and CSI measured using the one or more monitoring reference signals; and
transmit an indication of the prediction performance.

11. The apparatus of claim 1, wherein the predicted CSI or interference information is obtained based at least in part on an artificial intelligence or machine learning (AI/ML) model, and wherein the one or more processors are further configured to cause the UE to:
determine to continue using the AI/ML model based at least in part on a performance monitoring;
fall back to a non-AI/ML operation based at least in part on the performance monitoring;
fine-tune or switch an AI/ML mode based at least in part on the performance monitoring; or
receive a new AI/ML model based at least in part on the performance monitoring.

12. The apparatus of claim 1, wherein the predicted CSI or interference information is obtained based at least in part on an artificial intelligence or machine learning (AI/ML) model, wherein input data and output data to the AI/ML model is consistent across training and inference, wherein an input to the AI/ML model is a measured channel or interference on the first frequency sub-band, and wherein an output of the AI/ML model is the predicted CSI or interference information on the second frequency sub-band.

13. The apparatus of claim 1, wherein the one or more processors are further configured to cause the UE to:
transmit, during a data collection mode, a request for a plurality of reference signals on a plurality of frequency sub-bands; and
receive, in response to the request, the plurality of reference signals on the plurality of frequency sub-bands, wherein a prediction model is trained based at least in part on the plurality of reference signals on the plurality of frequency sub-bands.

14. The apparatus of claim 1, wherein the one or more processors are further configured to cause the UE to:
transmit a UE capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.

15. An apparatus for wireless communication at a network node, comprising:
one or more memories; and
one or more processors, coupled to the one or more memories, configured to cause the network node to:
transmit a configuration that indicates a first frequency sub-band and a second frequency sub-band, wherein the first frequency sub-band is associated with measurement and the second frequency sub-band is associated with prediction; and
receive, based at least in part on the configuration, a report that indicates predicted channel state information (CSI) or interference information on the second frequency sub-band.

16. The apparatus of claim 15, wherein the one or more processors are further configured to cause the network node to:
receive an indication of a prediction performance, wherein one or more monitoring reference signals are measured to monitor the prediction performance, and wherein the prediction performance is based at least in part on a comparison of CSI predicted on the second frequency sub-band and CSI measured using the one or more monitoring reference signals.

17. The apparatus of claim 15, wherein the predicted CSI or interference information is obtained based at least in part on an artificial intelligence or machine learning (AI/ML) model, and wherein the one or more processors are further configured to cause the network node to:
transmit a new AI/ML model based at least in part on a performance monitoring.

18. The apparatus of claim 15, wherein the one or more processors are further configured to cause the network node to:
receive, during a data collection mode, a request for a plurality of reference signals on a plurality of frequency sub-bands; and
transmit, in response to the request, the plurality of reference signals on the plurality of frequency sub-bands, wherein a prediction model is trained based at least in part on the plurality of reference signals on the plurality of frequency sub-bands.

19. The apparatus of claim 15, wherein the one or more processors are further configured to cause the network node to:
receive a user equipment capability indication that indicates one or more of: whether or not CSI prediction is supported, supported bands for CSI prediction, whether CSI prediction for the carrier aggregation mode or the dual connectivity mode is supported, whether inter-band CSI prediction or intra-band CSI prediction is supported, one or more numerologies associated with CSI prediction, a scheduling offset associated with CSI prediction, or a frequency separation associated with CSI prediction.

20. A method of wireless communication performed by a user equipment (UE), comprising:
receiving a configuration that indicates a first frequency sub-band and a second frequency sub-band, wherein the first frequency sub-band is associated with measurement and the second frequency sub-band is associated with prediction; and
transmitting, based at least in part on the configuration, a report that indicates predicted channel state information (CSI) or interference information on the second frequency sub-band.
